(19) United States
(12) Patent Application Publication
(10) Pub. No.: US 2015/0276420 A1
(43) Pub. Date: Oct. 1, 2015

(54) CROWD SOURCED ENERGY ESTIMATION

(71) Applicant: FORD GLOBAL TECHNOLOGIES, LLC, Dearborn, MI (US)

(72) Inventors: RYAN ABRAHAM McGEE, Shanghai (CN); FLING TSENG, Ann Arbor, MI (US); JOHANNES GEIR KRISTINSSON, Ann Arbor, MI (US)

(73) Assignee: FORD GLOBAL TECHNOLOGIES, LLC, Dearborn, MI (US)

(21) Appl. No.: 14/231,045

(22) Filed: Mar. 31, 2014

(51) Int. Cl. G01C 21/34

(52) U.S. Cl. CPC G01C 21/3469

(57) ABSTRACT

A method of advising a driver of a vehicle may include at a computing system, receiving from the vehicle a predicted energy usage request for a selected route. In response to the request, the method may further include transmitting for each of a plurality of segments defining the selected route, an energy usage estimate based on data indicative of propulsive energy previously used by vehicles to travel the segments and to travel other segments having common characteristics with the segments.

### TECHNICAL FIELD

The present disclosure relates to a method of advising a driver of vehicle.

### BACKGROUND

Vehicle energy usage estimations along a route may be difficult to accurately predict using current methods. There are two primary methods implemented to estimate a vehicle's energy usage along a route: physics based and statistics based. The physics based methods require knowledge of the road topology, vehicle properties, and assumptions about the vehicle speed along the route. The statistics based approaches utilize drive history information and make assumptions that the future energy consumption will match the recent driving history.

### SUMMARY

In at least one embodiment, a method of advising a driver of a vehicle is provided. The method may include at a computing system, receiving from a vehicle a predicted energy usage request for a selected route. In response to the request, the method may further include transmitting for each of a plurality of segments defining the selected route, an energy usage estimate based on data indicative of propulsive energy previously used by vehicles to travel the segments and to travel other segments having common characteristics with the segments.

In at least one embodiment, a vehicle navigation system is provided. The vehicle navigation system may include at least one controller programmed to transmit to an off-vehicle computing arrangement an energy usage request for a selected route. The at least controller may be further programmed, in response to the request, to receive an energy usage estimate for each of a plurality of segments defining the selected route from the arrangement. The estimate may be based on data indicative of propulsive energy previously used by vehicles to travel the segments and to travel other segments having common characteristics with the segments. The at least one controller may be further programmed to output the estimate for display.

In at least one embodiment, a method of advising a driver of a vehicle is provided. The method may include transmitting to an off-vehicle computing arrangement an energy usage prediction request for a selected route. The method may further include receiving, in response to the request, an energy usage prediction for each of a plurality of segments defining the selected route from the arrangement. The prediction may be based on data indicative of propulsive energy previously used by vehicles to travel the segments and to travel other segments having common characteristics with the segments. The method may further include outputting the prediction for display.

### BRIEF DESCRIPTION OF THE DRAWINGS

FIG. 1 is a schematic representation of an exemplary crowd sourced energy usage estimator.

FIG. 2 is a schematic representation of a portion of the crowd sourced energy usage estimator of FIG. 1.

FIG. 3 is a flowchart of a method of advising a driver of a vehicle.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

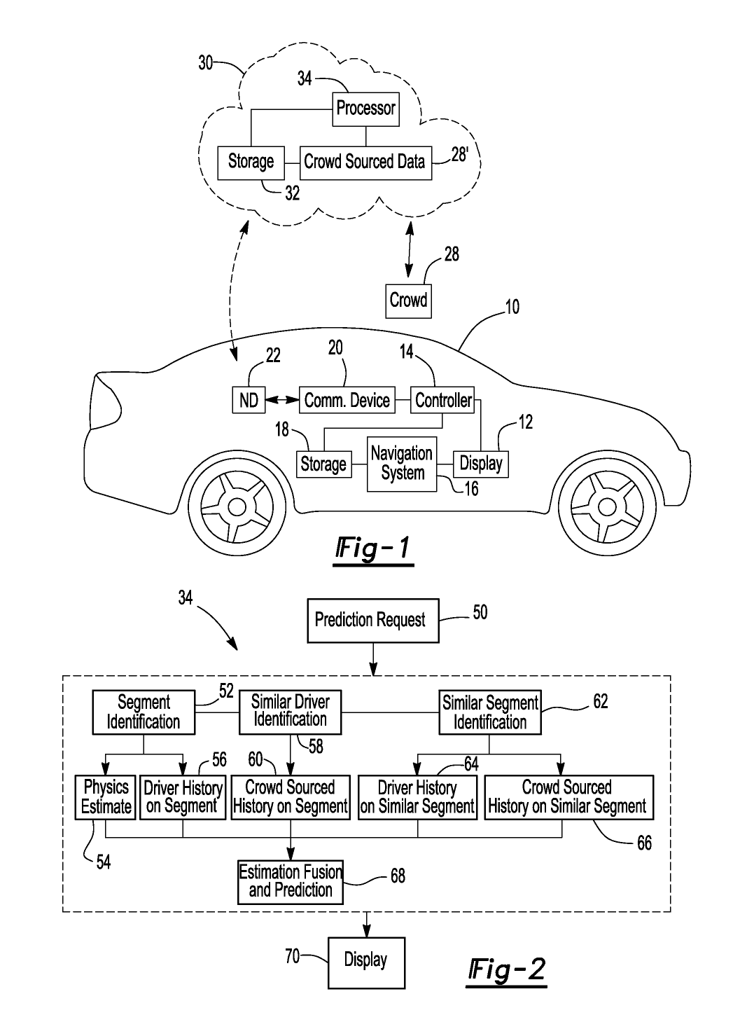

FIG. 1 illustrates a vehicle 10 in communication with an off-vehicle computing arrangement 30. The vehicle 10 may be a hybrid electric vehicle, a conventional vehicle having an engine that drives a transmission or a fully electric vehicle having a powertrain including a traction battery and a traction motor.

The vehicle 10 may be provided with a vehicle-based computing system which may contain a display interface 12, a controller 14, a navigation system 16, a computer readable storage system 18 and a communications device 20. The driver of the vehicle may be able to interact with the interface, for example, through a touch sensitive screen. The interaction may occur through button presses, a spoken dialog system with automatic speech recognition and speech synthesis.

The vehicle 10, which may be of any suitable configuration, may expend propulsive energy to propel the vehicle across various road segments. The propulsive energy expended by the vehicle may be determined by monitoring various sensors or modules in communication with the controller 14 and powertrain components. These sensors or modules may continuously or intermittently monitor vehicle propulsive energy expenditures such as battery power consumed, miles per gallon consumed, miles per gallon equivalent, joules per kilometer, watt-hours per kilometer, liters per kilometer or various other measures of propulsive energy expenditure known to those of ordinary skill in the art.

The measures of propulsive energy may be stored locally on the computer readable storage device 18. Computer readable storage devices or media may include volatile and nonvolatile storage in read-only memory (ROM), random-access memory (RAM), and keep-alive memory (KAM), for example. KAM is a persistent or non-volatile memory that may be used to store various operating variables while the CPU is powered down. Computer-readable storage devices or media may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller in controlling the engine or vehicle.

The vehicle 10 may use a communications device 20 to communicate with the off-vehicle computing arrangement 30. The communication device 20 may be a BLUETOOTH transceiver configured to communicate with a nomadic device 22 (e.g., cell phone, smart phone, PDA, or any other device having wireless remote network connectivity). The nomadic device 22 may then be used to communicate with the off-vehicle computing arrangement 30 through, for example, communication with a cellular tower.

The communications device 20 maybe a data-plan, data over voice, or DTMF tones associated with nomadic device 22. Alternatively, the communications device 20 may be an onboard modem having antenna in order to communicate data between the controller 14 and the off-vehicle computing arrangement 30 over the voice band.

In another embodiment, nomadic device 22 may be replaced with a cellular communication device (not shown) that is installed within the vehicle 10. In yet another embodiment, the communications device 20 may be a wireless local area network (LAN) device capable of communication over, for example (and without limitation), an 802.11g network (i.e., WiFi) or a WiMax network.

Also, or alternatively, the communications device 20 may be configured as a vehicle based wireless router, using for example a WiFi (IEEE 803.11) transceiver. This may allow the controller 14 to connect to remote networks in range of a local router.

In one embodiment, incoming data from the off-vehicle computing arrangement 30 may be passed through the nomadic device 22 via a data-over-voice or data-plan, through the onboard BLUETOOTH transceiver and into the controller 14. In the case of certain temporary data, for example, the data may be stored on the HDD or other storage media until such time as the data is no longer needed.

The vehicle 10 may be configured to advise the driver of an estimate or prediction of propulsive energy that may be expended by the vehicle 10 to traverse a particular route or road segments. The estimate may be displayed to the driver in the form of a vehicle range estimate, distance to empty calculation, energy consumption efficiency (gallons per 100 miles, etc.), rate of energy consumption data, smart route algorithm or state of charge planning. Such estimates may be determined by various approaches including physics based and a statistics based approaches.

The physics based approaches may utilize knowledge of the road topology, vehicle properties, and assumptions about the expected vehicle speed along the route. The physics based approaches may utilize route information from the navigation system 16 to obtain road topology. The navigation system 16 may be configured to identify road segments or be configured to section the route into road segments. The statistics based approaches may utilize vehicle drive history information and make assumptions that the future energy consumption will match the vehicle's recent driving history.

The vehicle 10 and the off-vehicle computing arrangement 30 may also utilize crowd sourced data 28 communicated to the off-vehicle computing arrangement 30 to build a driver specific propulsive energy estimate for each road segment or range estimate or prediction using the statistic based approaches.

As the vehicle 10 traverses various road segments, drive history data may be uploaded to the off-vehicle computing arrangement 30. The drive history data may include an identification of a road segment and the propulsive energy expended to traverse the segment while rendering anonymous the actual driver's identifying information. At least a portion of the drive history data from a plurality of vehicles, crowd sourced data 28′, may also be communicated to the off-vehicle computing arrangement 30. The crowd sourced data 28′ may be tagged with individual user profiles or identifiers, which may indicate the vehicle type, the driver and vehicle system, the driving style of the driver (aggressive, defensive, etc.) The off-vehicle computing arrangement 30 may use the uploaded data to perform various statistics based approaches to build the driver specific propulsive energy estimate.

The off-vehicle computing arrangement 30 may be a cloud based computing system, remote computing system or the like. The off-vehicle computing arrangement 30 may include computer readable storage 32. The propulsive energy expended by the vehicle and at least a portion of the crowd sourced data 28′ may be stored in the off-vehicle computing arrangement 30.

The off-vehicle computing arrangement 30 may be provided with a processor 34 configured to receive the driving history data, the crowd sourced information, and the propulsive energy data and determine or calculate a driver specific propulsive energy prediction to the vehicle 10 in response to a propulsive energy estimation request. The processor 34 may alternatively be onboard the vehicle 10 and configured to interact with the off-vehicle computing arrangement 30 to perform the operations discussed below.

Referring now to FIG. 2, upon receiving a prediction request 50 from the vehicle 10, the off-vehicle computing system 30 may attempt to provide a propulsive energy estimate to the vehicle 10. The processor 34 may perform the estimates in parallel or sequentially or may employ particular approaches based on the level of information available.

The prediction request 50 may request a propulsive energy usage estimate for an ordered set of road segments that make up a route (for fixed-route-based applications) or as an unordered set of geographically constrained segments (for route-creation applications). The segments may be processed individually by the processor 34 to provide an energy estimation for each segment which may then be aggregated to provide a propulsive energy estimate to a driver for the selected route. Alternatively, a total vehicle range may be estimated based on the unordered set of geographically constrained segments.

The processor may employ the physics based approaches or statistics based approaches by identifying the road segments 52 that make up the route. The road topology information may be retrieved and the physics based approach 54 may be employed. The physics based approach 54 may estimate the propulsive energy used by the vehicle 10 based on properties of the road segment, mass of the vehicle, other vehicle properties, and assumptions about the vehicle speed on the segment. The other vehicle properties may include vehicle powertrain configuration, engine size, gear ratio, battery size, battery discharge rate, current state of charge, etc.

The off-vehicle computing arrangement 30 may also provide a propulsive energy usage estimate based on the vehicle's driving history 56 on the identified segment. The estimate may be a mean, maximum, mean +1 standard deviation or the like of the propulsive energy previously expended by the vehicle when it has previously traversed the road segment. The accuracy of the estimate may be increased depending on the number of times the vehicle has traversed the road segment providing a larger sample size.

In some situations the vehicle 10 may not have traversed the identified road segment or have not traversed the identified road segment a threshold number of times to provide an accurate propulsive energy usage estimate based on the vehicle 10 driving history on the road segment. The at least a portion of the crowd sourced data 28′ provided to the off-vehicle computing system 30 may contain crowd sourced driving history data for the identified segment or segments. The processor 34 may retrieve the user-profile of the driver of the vehicle 10 and identify similar drivers 58 from the crowd sourced data 28′. Similar drivers to the driver of the vehicle 10 may have common characteristics with the driver of the vehicle 10 and the vehicle 10. Common characteristics may include vehicle type (e.g. compact, truck, van, full size), vehicle configuration, propulsion method (e.g. internal combustion engine, electric vehicle, fuel cell) driving style, vehicle mass, rated vehicle fuel economy (e.g. EPA label fuel economy rating) and driver profile.

Comparisons may be made between the user profile of the driver of the vehicle 10 and the user profiles of the drivers of the vehicles to identify the common characteristics used to make a prediction. With the common characteristics, a transformation may be applied when using the crowd source driving history on the identified segment 60 since each user's driving history data may be different. For example, if one user drives more aggressively and has a vehicle with more mass than the vehicle 10, the user may have a higher energy usage level as compared to the driver of the vehicle 10. Therefore to use this higher energy estimation as data to perform the propulsive energy usage estimate for the driver of the vehicle 10, a transformation may be applied based on the common characteristics between the users. The transformation may also be applied based on additional common characteristics between the vehicles. The more common characteristics between the driver, the vehicles, and the crowd sourced driving history for the identified segment, the better the accuracy of the propulsive energy usage estimate.

The off-vehicle computing system 30 may also provide a propulsive energy usage estimate or prediction for the driver of the vehicle 10 for road segments the vehicle 10 has not previously traversed. If the vehicle 10 has not driven a particular segment, other segments with common characteristics or similar properties with previously traversed road segments may be identified 62.

The common characteristics between road segments may include expected number of stops, expected stop durations, speed limits, length of road, road grade, geographic location of the road segment, direction of travel, and traffic density. For example, the vehicle 10 may not have traversed between mile posts 1-20 along the Ohio Turnpike, but may have been driven between mile posts 21-40, which may have a similar speed limit, road length, and road grade as mile posts 1-20. In this case, a transformation may be applied to the similar road segment previously traversed 64 (mile posts 21-40) by the driver of the vehicle 10 and the identified road segment (mile post 1-20), to calculate the propulsive energy usage estimate. The more common characteristics or similarities between the identified segment and the similar road segment, the more accurate the propulsive energy usage estimate may be.

Alternatively, the crowd sourced driving history data on similar road segments 66 may be used. The situation may arise when the driver of the vehicle 10 has not previously traversed the road segment, or there is limited data available on similar road segments the driver of the vehicle 10 has traversed, or there is limited crowd sourced history for drivers of vehicles on the identified segment. Two transformations may be applied, the first to identify common characteristics between the driver of the vehicle 10 and the crowd sourced driver data, and the second to identify common characteristics between the identified road segment, the driver, the vehicles and the crowd sourced driver data on the identified segment.

The above mentioned approaches may be fused together into an energy usage estimate 68 based on the level of information available. The fusion may be a weighted average of all of the above approaches or at least a portion of the above mentioned approaches. The energy usage estimate may be a weighted average of the propulsive energy previously used by other drivers and vehicles to travel the road segments and to travel other road segments having common characteristics with the road segments. The energy usage estimate may also include the propulsive energy previously used by the vehicle 10 to travel the road segments and to travel other road segments having common characteristics with the road segments. The approaches utilizing the drive history of the driver of the vehicle 10 may be accorded greater weight in the fusion. The driver of the vehicle may be able to select the weight given to the various approaches. The estimate may ultimately be displayed 70 to the driver via the display interface 12.

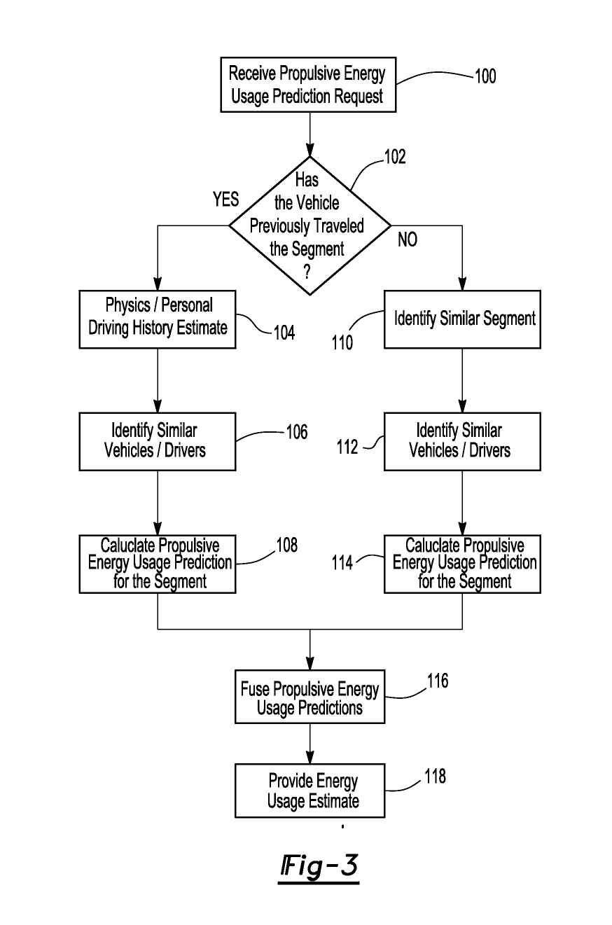

Referring now to FIG. 3, a flow chart of an exemplary method of advising a driver of a vehicle is shown. As will be appreciated by one of ordinary skill in the art, the flowchart represents control logic which may be implemented or affected in hardware, software, or a combination of hardware and software. For example, the various functions may be affected by a programmed microprocessor. The control logic may be implemented using any of a number of known programming and processing techniques or strategies and is not limited to the order or sequence illustrated. For instance, interrupt or event-driven processing may be employed in real-time control applications rather than a purely sequential strategy as illustrated Likewise, parallel processing, multitasking, or multi-threaded systems and methods may be used.

Control logic may be independent of the particular programming language, operating system, processor, or circuitry used to develop and/or implement the control logic illustrated. Likewise, depending upon the particular programming language and processing strategy, various functions may be performed in the sequence illustrated, at substantially the same time, or in a different sequence while accomplishing the method of control. The illustrated functions may be modified, or in some cases omitted, without departing from the scope intended.

The driver may utilize the navigation system 16 to map out a desired route or road segments to travel. The route may be determined by the driver selecting a point of interest via the display interface 12 and the navigation system 16 providing available routes to reach the point of interest. Alternatively, the driver may piece together various road segments comprising a route to a point of interest. At block 100, the method may receive a predicted energy usage request along with the selected route. The driver may want to determine the amount of propulsive energy that may be expended by the vehicle along a selected route to plan fuel efficient travel routes. The driver may also wish to determine the maximum distance the vehicle may be able to travel given the vehicle's present level of fuel or state of charge, etc.

Upon receiving the desired route or road segments, at block 102 the method may identify the road segment(s) and determine whether the vehicle has previously traversed the road segment(s) that comprise the desired route. If the vehicle has previously traversed the road segments, at block 104 the method may determine or calculate an estimated or predicted amount of propulsive energy usage by the vehicle to traverse the road segments using the above mentioned physics based approach or based on the driver's historical energy usage along the road segment. At block 106, the method may in parallel, sequentially, or alternatively identify drivers and vehicles with common (similar) characteristics with the driver and the vehicle. At block 108, the method may then calculate an estimated or predicted amount of propulsive energy usage by the vehicle to traverse the road segments using the crowd sourced driving history of similar drivers and vehicles along the road segments.

If the vehicle has not previously traversed the road segments or has not traversed the road segments a threshold amount of times to provide statistical accuracy, at block 110, the method may identify road segments with common (similar) characteristics with the identified road segments. At block 112, the method may also identify drivers and vehicles with common (similar) characteristics with the driver and the vehicle. At block 114, the method may calculate an estimated amount of propulsive energy usage by the vehicle to traverse the road segments using the above mentioned driving history of the vehicle on similar road segments or the crowd sourced driving history on similar road segments.

At block 116, the method may aggregate the energy usage estimates for the road segments that comprise the desired route and fuse the various estimates or predictions together. As stated previously, the fusion may be a weighted average of the various estimates or predictions. At block 118, the method may provide the propulsive energy usage estimate to the driver through the display or other available devices.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A method of advising a driver of a vehicle comprising:
at a computing system,
receiving from a vehicle a predicted energy usage request for a selected route; and
in response to the request, transmitting for each of a plurality of segments defining the selected route, an energy usage estimate based on data indicative of propulsive energy previously used by vehicles to travel the segments and to travel other segments having common characteristics with the segments.

2. The method of claim 1 wherein the common characteristics include speed limit, road grade, expected number of stops, geographical location, direction of travel, traffic density, or road length.

3. The method of claim 1 further comprising, at the computing system, in response to the request, transmitting for each of a plurality of segments defining the selected route, an energy usage estimate based on data indicative of propulsive energy previously used by the vehicle to travel the segments and to travel other segments having common characteristics with the segments.

4. The method of claim 1 wherein the data indicative of propulsive energy includes battery power consumed, miles per gallon, miles per gallon equivalent, joules per kilometer, watt-hours per kilometer, or liters per kilometer.

5. The method of claim 1 further comprising, at a computing system, tagging the propulsive energy previously used by the vehicle to travel the plurality of segments with an identifier of the driver of the vehicle and the vehicle.

6. The method of claim 1 wherein the selected route is at least one of an ordered set of road segments and an unordered set of geographically constrained road segments.

7. The method of claim 3 wherein the energy usage estimate is a weighted average of the propulsive energy previously used by vehicles to travel the segments and to travel other segments having common characteristics with the segments and the propulsive energy previously used by the vehicle to travel the segments and to travel other segments having common characteristics with the segments.

8. A vehicle navigation system comprising:
at least one controller programmed to
transmit to an off-vehicle computing arrangement an energy usage request for a selected route;
receive, in response to the request, an energy usage estimate for each of a plurality of segments defining the selected route from the arrangement, wherein the estimate is based on data indicative of propulsive energy previously used by vehicles to travel the segments and to travel other segments having common characteristics with the segments; and
output the estimate for display.

9. The vehicle navigation system of claim 8 wherein the request identifies a type of the vehicle and wherein the vehicles are of a same type as the vehicle.

10. The vehicle navigation system of claim 8 wherein the request identifies a driving style of a driver of the vehicle and wherein the vehicles have drivers with common characteristics as the driver of the vehicle.

11. The vehicle navigation system of claim 8 wherein the at least one controller is further programmed to transmit to the off-vehicle computing arrangement data indicative of propulsive energy used by the vehicle to travel segments of routes.

12. The vehicle navigation system of claim 8 wherein the estimate includes distance to empty data, energy consumption efficiency, or rate of energy consumption data.

13. The vehicle navigation system of claim 8 wherein the vehicle is one of the vehicles.

14. The vehicle navigation system of claim 8 wherein the estimate is further based on a mass of the vehicle, a type of the vehicle, or an expected speed of the vehicle.

15. A method of advising a driver of a vehicle comprising:
transmitting to an off-vehicle computing arrangement an energy usage prediction request for a selected route;
receiving, in response to the request, an energy usage prediction for each of a plurality of segments defining the selected route from the arrangement, wherein the prediction is based on data indicative of propulsive energy previously used by vehicles to travel the segments and to travel other segments having common characteristics with the segments; and
outputting the prediction for display.

16. The method of claim 15 wherein the request identifies a type of the vehicle and wherein the vehicles are of a same type as the vehicle.

17. The method of claim 15 wherein the request identifies a driving style of a driver of the vehicle and wherein the vehicles have drivers with a same driving style as the driver of the vehicle.

18. The method of claim 15 further comprises transmitting to the off-vehicle computing arrangement data indicative of propulsive energy used by the vehicle to travel segments of routes.

19. The method of claim 15 wherein the prediction includes distance to empty data or rate of energy consumption data.

20. The method of claim 15 wherein the vehicle is one of the vehicles.
